(19) United States
(12) Patent Application Publication
(10) Pub. No.: US 2018/0178631 A1
(43) Pub. Date: Jun. 28, 2018

(54) HEATER APPARATUS AND WORK VEHICLE

(71) Applicant: Komatsu Ltd., Tokyo (JP)

(72) Inventors: Kouhei Yamamoto, Tokyo (JP); Yasuyuki Tagami, Tokyo (JP)

(21) Appl. No.: 15/511,354

(22) PCT Filed: Dec. 27, 2016
(86) PCT No.: PCT/JP2016/088945

§ 371 Date: Mar. 15, 2017

(51) Int. Cl. B60H 1/22; B60H 1/00; B60S 1/02; B60S 1/54

(52) U.S. Cl. CPC B60H 1/2225; B60H 1/00392; B60S 1/54; B60S 1/023; B60H 1/00564

(57) ABSTRACT

A heater apparatus includes a housing which is arranged in a step positioned at an outer side of a floor plate of a vehicle body of a work vehicle in a vehicle width direction and has an air intake and a warm air blowoff port; an electric heater arranged in an inner space of the housing; a fan which supplies air to the electric heater; and a supporting member which supports the electric heater and the fan. The electric heater is arranged so that a rear end of the electric heater is arranged at a position lower than a front end of the electric heater.

### FIELD

The present invention relates to a heater apparatus and a work vehicle.

### BACKGROUND

In the technical field related to work vehicles such as forklifts, a work vehicle has been known which includes a heater apparatus that generates warm air as disclosed in Patent Literature 1.

### CITATION LIST

### Patent Literature

Patent Literature 1: Japanese Laid-open Patent Publication No. 2000-071945

### SUMMARY

### Technical Problem

As work vehicles, an engine forklift, which uses an internal combustion engine such as a diesel engine as a power source, and a battery forklift, which uses a battery as a power source, have been known. A heater apparatus installed in an engine forklift generates warm air by using heat generated in the internal combustion engine. Specifically, in an engine forklift, the internal combustion engine is used as a heat source for the heater apparatus. It is desired to install a heater apparatus also in battery forklifts.

An object of an aspect of the invention is to provide a heater apparatus and a work vehicle capable of generating warm air without using an internal combustion engine.

### Solution to Problem

According to a first aspect of the present invention, a heater apparatus comprises: a housing which is arranged in a step positioned at an outer side of a floor plate of a vehicle body of a work vehicle in a vehicle width direction and has an air intake and a warm air blowoff port; an electric heater arranged in an inner space of the housing; a fan which supplies air to the electric heater; and a supporting member which supports the electric heater and the fan, wherein the electric heater is arranged so that a rear end of the electric heater is arranged at a position lower than a front end of the electric heater.

According to a second aspect of the present invention, a work vehicle comprises the heater apparatus according to the first aspect.

### Advantageous Effects of Invention

According to an aspect of the invention, a heater apparatus and a work vehicle capable of generating warm air without using an internal combustion engine is provided.

### BRIEF DESCRIPTION OF DRAWINGS

FIG. 1 is a perspective view which illustrates an example of a work vehicle according to an embodiment of the present invention.

FIG. 2 is a side view of an example of a heater apparatus according to the present embodiment viewed from the right side.

FIG. 3 is a perspective view of an example of the heater apparatus according to the present embodiment viewed from the right rear side.

FIG. 4 is a perspective view of an example of the heater apparatus according to the present embodiment from the upper side.

FIG. 5 is a perspective view of an example of the heater apparatus according to the present embodiment viewed from the right front side.

FIG. 6 is a cross section which illustrates an example of a main unit according to the present embodiment.

FIG. 7 is a cross section which illustrates an example of a main unit according to the present embodiment.

FIG. 8 is a perspective view which schematically illustrates an external appearance of an electric heater and a fan supported by a supporting member according to the present embodiment.

FIG. 9 is a perspective view which illustrates an example of an electric heater according to the present embodiment.

FIG. 10 is a perspective view which illustrates an example of a defroster according to the present embodiment.

FIG. 11 is a cross section of an example of the defroster according to the present embodiment viewed from the front side.

### DESCRIPTION OF EMBODIMENTS

Embodiments of the present invention will be described below with reference to attached drawings, but the present invention is not limited to them. Components of the embodiments described below can be appropriately used in combination. Moreover, in some configurations, a part of the components may be unused.

### Work Vehicle

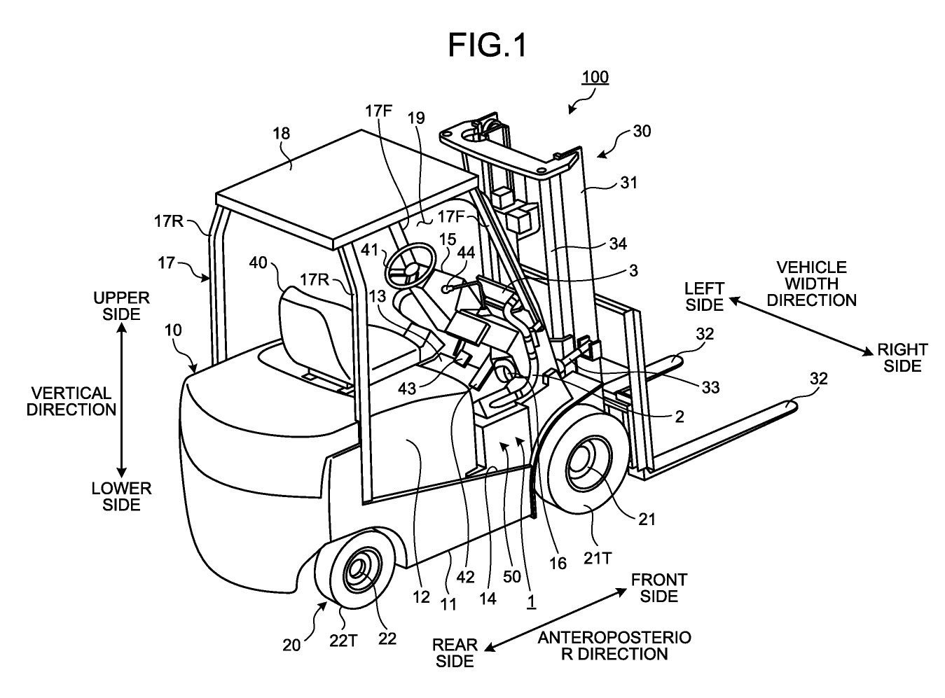

FIG. 1 is a perspective view which illustrates an example of a work vehicle 100 according to the present embodiment. In the present embodiment, the work vehicle 100 is a forklift 100. In the present embodiment, the forklift 100 is a battery forklift which uses a battery as a power source.

Referring to FIG. 1, the forklift 100 includes a vehicle body 10, a traveling device 20 which supports the vehicle body 10, a cargo handling device 30 supported by the vehicle body 10, a driving seat 40 supported by the vehicle body 10, and a heater apparatus 1 which generates warm air.

The traveling device 20 includes front wheels 21 and rear wheels 22. The front wheels 21 and the rear wheels 22 can rotate around a rotational axis. Tires 21T are installed in the front wheels 21. Tires 22T are installed in the rear wheels 22.

In the following description, a direction parallel to the rotational axes of the front wheels 21 and the rear wheels 22 when the forklift 100 travels in a straight traveling state will be appropriately referred to as a “vehicle width direction” of the vehicle body 10, a direction parallel to the vertical axes orthogonal to the ground on which the tires 21T and the tires 22T travel will be appropriately referred to as a “vertical direction” of the vehicle body 10, and a direction orthogonal to both the rotational axes and the vertical axes will be appropriately referred to as a “anteroposterior direction” of the vehicle body 10.

In the present embodiment, a side of a direction in which the cargo handling device 30 exists in relation to a driver seated on the driving seat 40 as the reference is the front side, and a side of the direction opposite to the front side is the rear side. One side in the vehicle width direction is the right side, and the other side in the vehicle width direction opposite to the right side is the left side. One side in the vertical direction is the upper side (corresponding to “above”, “higher”, or “upward”), and the other side in this direction opposite to the upper direction is the lower side (corresponding to “below” or “downward”).

The front wheels 21 are arranged on the front side of the rear wheels 22. The front wheels 21 are arranged on both sides of the vehicle body 10 in the vehicle width direction. The rear wheels 22 are arranged on both sides of the vehicle body 10 in the vehicle width direction.

The vehicle body 10 includes a frame 11, an accommodation member 12 supported by the frame 11 and including a battery chamber which accommodates a battery, a floor plate 13 arranged on the front side of the accommodation member 12, a step 14 arranged externally to the floor plate 13 in the vehicle width direction, and a dashboard 15 arranged at an anteroposterior position to the floor plate 13.

The accommodation member 12 supports the driving seat 40. The accommodation member 12 is arranged at a position lower than the driving seat 40. The battery is arranged in a battery chamber, which is an inner space of the accommodation member 12.

The battery is a rechargeable battery. A battery charging operation is performed periodically or when necessary. In the present embodiment, on the right side of the dashboard 15 of the vehicle body 10, a connector 16 for connection with a charging equipment for charging the battery is arranged. In the present embodiment, the connector 16 includes an insertion opening into which a charging plug is inserted.

The floor plate 13 is arranged between the accommodation member 12 and the dashboard 15 in the anteroposterior direction. The feet of the driver seated on the driving seat 40 are placed on the floor plate 13.

The step 14 is arranged on both sides of the floor plate 13 in the vehicle width direction. In the vehicle width direction, the step 14 is arranged adjacently to the floor plate 13. The driver steps onto the step 14 arranged on the left side in the vehicle width direction to enter and get off the vehicle. The driver steps up onto the driving seat 40 and down from the driving seat 40 via the step 14 arranged on the left side in the vehicle width direction.

The cargo handling device 30 includes a seat tube 31 supported by the frame 11 in a front portion of the frame 11, a fork 32 supported by the seat tube 31, a tilt cylinder 33 which tilts the seat tube 31 in the anteroposterior direction, and a lift cylinder 34 which moves the fork 32 in the vertical direction. Each of the tilt cylinder 33 and the lift cylinder 34 is a hydraulic cylinder. The fork 32 is driven by the lift cylinder 34 arranged in the seat tube 31 to be moved in the vertical direction while being supported by the seat tube 31.

The forklift 100 is operated by the driver seated on the driving seat 40. On the front side of the driving seat 40, a steering wheel 41 is arranged. The driver operates the steering wheel 41 by hand to control the traveling device 20.

In the front portion of the floor plate 13, an accelerator pedal 42 and a brake pedal 43 are arranged. The driver operates the accelerator pedal 42 and the brake pedal 43 by foot to drive and brake the traveling device 20.

Moreover, in the dashboard 15, an operation lever 44 for operating the cargo handling device 30 is arranged. The driver operates the operation lever 44 to drive the cargo handling device 30.

In addition, the forklift 100 includes multiple pillars 17, a head guard 18 supported by the multiple pillars 17, and a windshield 19 arranged on the front side of the dashboard 15. The pillars 17 include a pair of front pillars 17F and a pair of rear pillars 17R. The front pillars 17F are arranged on the front side of the rear pillars 17R. The Windshield 19 is arranged between the pair of front pillars 17F. The driver is allowed to visually identify an object in front and the state of the cargo handling device 30.

The heater apparatus 1 generates warm air. In the present embodiment, the heater apparatus 1 includes a main unit 50 which generates warm air and a defroster 3 which is connected to the main unit 50 via a tube member 2 and supplies the windshield 19 with the warm air from the main unit 50.

In the present embodiment, the main unit 50 of the heater apparatus 1 is arranged in the step 14 arranged on the right side in the vehicle width direction. The heater apparatus 1 supplies warm air to a space above the floor plate 13. If the forklift 100 is used in cold districts, discomfort felt by the driver due to cold is alleviated by the warm air supplied from the heater apparatus 1 to the space above the floor plate 13. Moreover, the heater apparatus 1 supplies warm air to the windshield 19 via the defroster 3. If the forklift 100 is used in cold districts, frost formation, ice accretion, and dew condensation are suppressed by the warm air supplied from the heater apparatus 1 to the windshield 19.

### Heater Apparatus

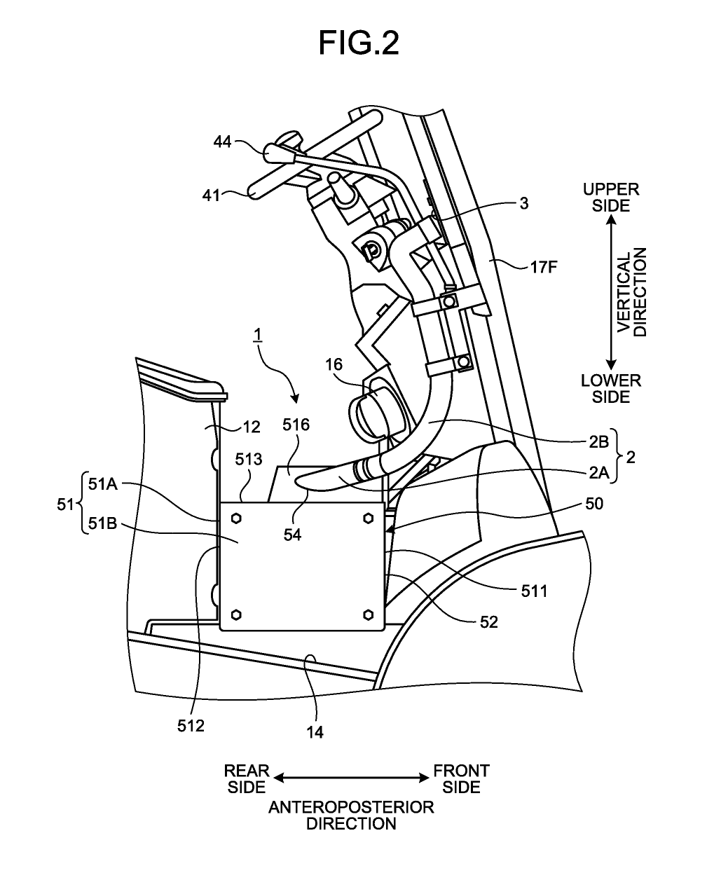

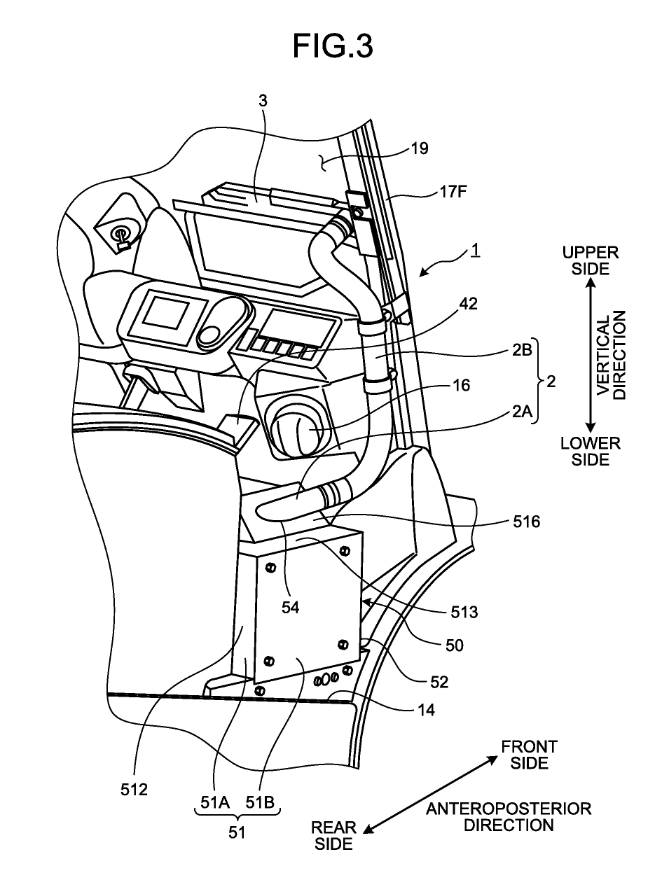

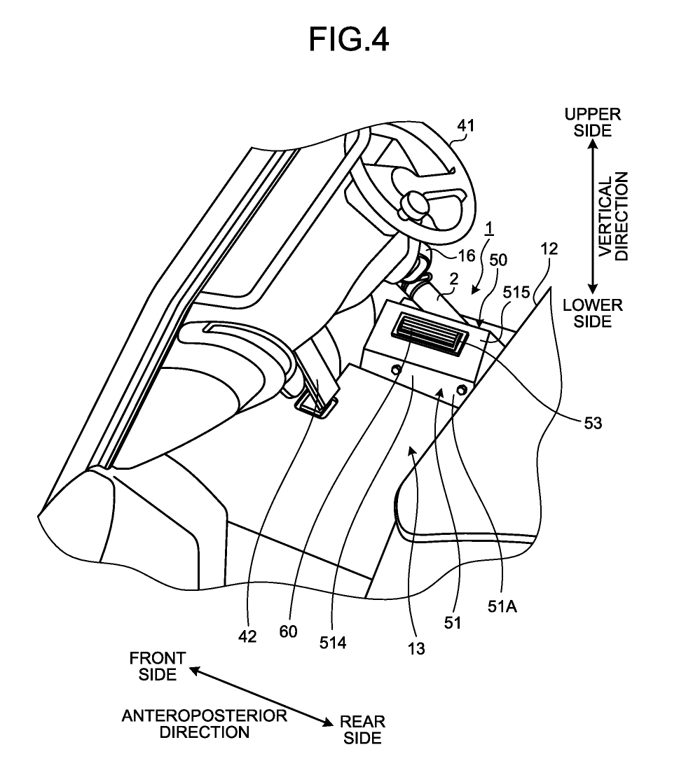

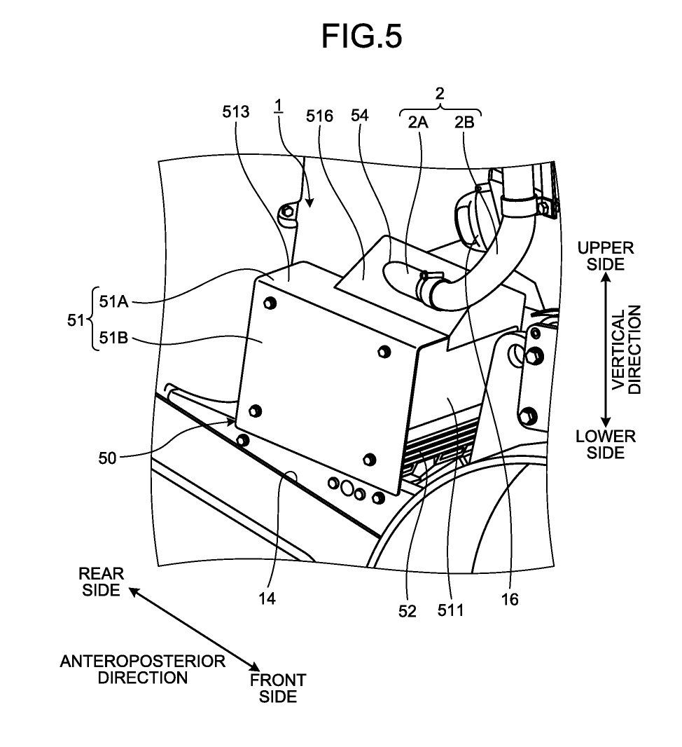

FIG. 2 is a side view which illustrates an example of the heater apparatus 1 according to the present embodiment viewed from the right side. FIG. 3 is a perspective view which illustrates an example of the heater apparatus 1 according to the present embodiment viewed from the right rear side. FIG. 4 is a perspective view which illustrates an example of the heater apparatus 1 according to the present embodiment from the upper side. FIG. 5 is a perspective view which illustrates an example of the heater apparatus 1 according to the present embodiment viewed from the right front side.

Referring to FIGS. 2 to 4, the main unit 50 of the heater apparatus 1 includes a housing 51. The housing 51 is arranged in the step 14 on the right side in the vehicle width direction. The housing 51 is a box-shaped member. The housing 51 is made of metal. Alternatively, the housing 51 may be made of plastic.

The housing 51 includes an air intake 52, a warm air blowoff port 53 for blowing warm air into the space above the floor plate 13, and a supply port 54 connected with the tube member 2.

The housing 51 includes a main body member 51A supported by the step 14 and a cover member 51B detachably connected with the main body member 51A. The cover member 51B is a plate-like member. The cover member 51B is fixed to the main body member 51A with fastening members such as bolts. By releasing the fixation with the fastening members, the cover member 51B is detached from the main body member 51A.

The main body member 51A includes an opening on an outer side in the vehicle width direction. In the present embodiment, the opening of the main body member 51A is oriented toward the right side in the vehicle width direction. The cover member 51B is connected to the main body member 51A so as to cover the opening of the main body member 51A. By releasing the fixation between the main body member 51A and the cover member 51B, an inner space of the housing 51 is exposed. In this state, the driver or an operator is allowed to perform an operation for equipments and members arranged in the inner space of the housing 51 via the opening of the main body member 51A arranged on the right side in the vehicle width direction.

The main body member 51A includes a front board 511 arranged in its front portion, a rear board 512 arranged in its rear portion, an upper board 513 arranged in its upper portion, and an inner board 514 arranged internally in the vehicle width direction. The opening of the main body member 51A is regulated by an external end of the front board 511 in the vehicle width direction, an external end of the rear board 512 in the vehicle width direction, an external end of the upper board 513 in the vehicle width direction, and the step 14. The cover member 51B of the housing 51 is arranged externally to the main body member 51A in the vehicle width direction so as to cover the opening of the main body member 51A.

Moreover, the main body member 51A includes a first inclined board 515 supported by the upper board 513 and a second inclined board 516 supported by the upper board 513.

The first inclined board 515 is arranged internally to the second inclined board 516 in the vehicle width direction. The first inclined board 515 includes a first inclined plane which is inclined upwards externally in the vehicle width direction. The second inclined board 516 includes a second inclined plane which is arranged externally to the first inclined plane in the vehicle width direction and inclined downward externally in the vehicle width direction.

The air intake 52 is arranged in a lower portion on a front surface of the front board 511. The warm air blowoff port 53 is arranged in the first inclined plane of the first inclined board 515. The supply port 54 is arranged in the second inclined plane of the second inclined board 516.

In the present embodiment, a louver 60 is arranged in the warm air blowoff port 53. The louver 60 includes a plurality of slats for adjusting the direction of supply of the warm air blown from the warm air blowoff port 53. By turning the louver 60, the driver can adjust the direction of supply of the warm air blown from the warm air blowoff port 53. Note that the louver 60 may be omitted.

The tube member 2 is connected with the housing 51. In the present embodiment, the tube member 2 includes a first tube member 2A, which is made of metal and fixed to the second inclined board 516, and a second tube member 2B, which is flexible and connects between the first tube member 2A and the defroster 3. The flow path of the first tube member 2A is connected with the supply port 54 arranged in the second inclined board 516. The second tube member 2B is fixed to the dashboard 15 and the front pillar 17F by using fixing members. The defroster 3 is connected with the housing 51 via the tube member 2. The defroster 3 supplies the warm air from the housing 51 to the windshield 19.

Referring to FIG. 4, in the present embodiment, the warm air blowoff port 53 is arranged at a position higher than an upper surface of the floor plate 13.

The connector 16 is arranged at an anteroposterior position to the housing 51. Referring to FIGS. 2, 3, 4, and 5, an upper end of the housing 51 is disposed below the connector 16, which is connected with the charging equipment for charging the battery. In the vertical direction, the first inclined board 515 in which the warm air blowoff port 53 is provided is arranged between an upper surface of the floor plate 13 and the connector 16.

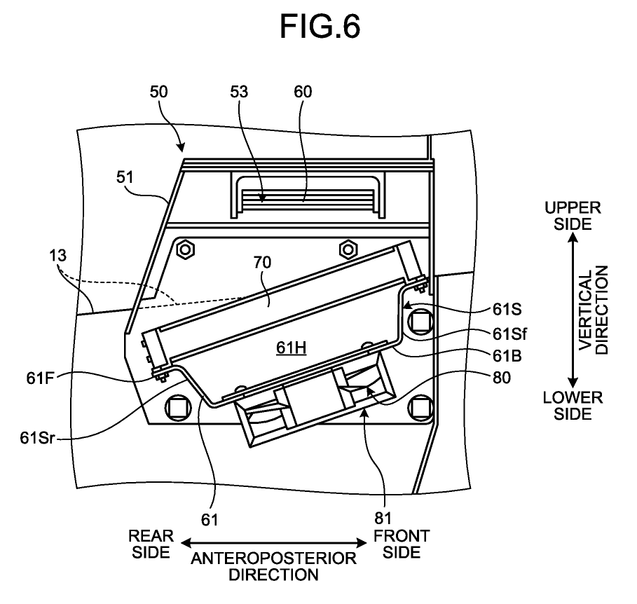

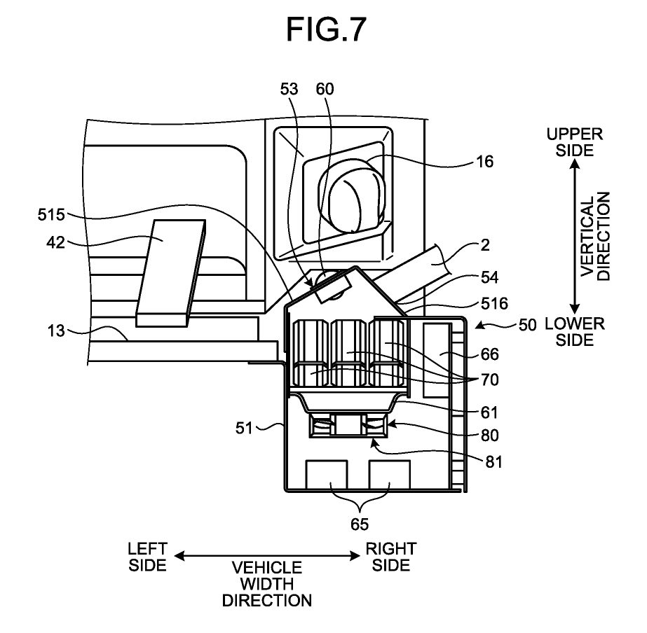

FIG. 6 is a cross section of an example of the main unit 50 according to the present embodiment. FIG. 7 is a cross section of an example of the main unit 50 according to the present embodiment. FIG. 6 is a cross section of the inner space of the housing 51 viewed from the right side, and FIG. 7 is a cross section of the inner space of the housing 51 viewed from the rear side.

Referring to FIGS. 6 and 7, the heater apparatus 1 includes an electric heater 70 arranged in the inner space of the housing 51, a fan 80 which is arranged in the inner space of the housing 51 and feeds air to the electric heater 70, and a supporting member 61 supporting the electric heater 70 and the fan 80. The air intake 52, the fan 80, the electric heater 70, and the warm air blowoff port 53 are arranged in this order in the direction of air flow.

The electric heater 70 is a heat wire heater. The electric heater 70 generates heat by electric power supplied from the battery. In the present embodiment, the electric heater 70 is a positive temperature coefficient (PTC) heater, which is a kind of heat wire heater. The electric heater 70 has an outer shape that is longer in the anteroposterior direction. A plurality of electric heaters 70 is arranged in the vehicle width direction. In the present embodiment, three electric heaters 70 are arranged in the vehicle width direction. The electric heaters 70 are arranged so that adjacent heaters are arranged with an interval. The plurality of electric heater 70 is supported by the supporting member 61.

The fan 80 is arranged at a position lower than the electric heater 70. The fan 80 is an axial fan, for example, and is turned by an operation of an actuator such as a motor. The fan 80 is arranged inside a fan casing 81. The fan casing 81 is a cylindrical member, for example. The fan 80 is turnably supported by the fan casing 81. The fan 80 rotates inside the fan casing 81. The fan casing 81 is connected with the supporting member 61. When the fan 80 turns, air in a space external to the housing 51 flows into the inner space of the housing 51 via the air intake 52 and fed to the electric heater 70.

The supporting member 61 supports the electric heater 70 and the fan 80. The supporting member 61 is arranged between the electric heater 70 and the fan 80. As illustrated in FIG. 7, the supporting member 61 is coupled with an inner surface of the housing 51. The housing 51 is connected with at least one part of the step 14. Moreover, the housing 51 supports an electronic circuit 65 and a control device 66 for driving the electric heater 70 and the fan 50.

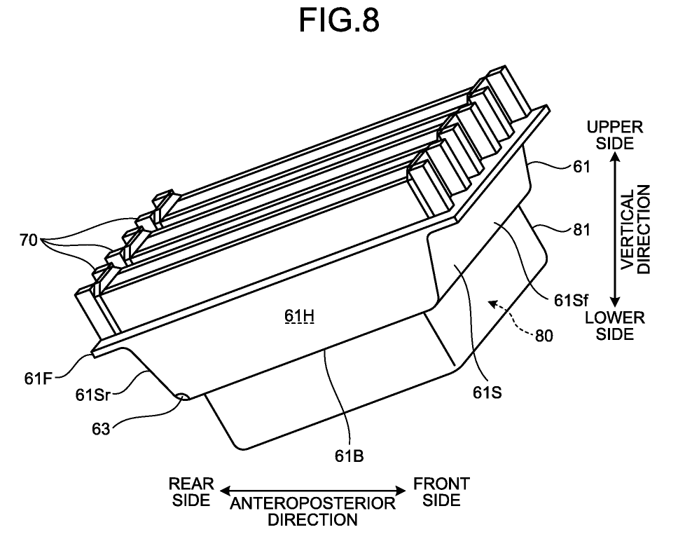

FIG. 8 is a perspective view which schematically illustrates an external appearance of the electric heater 70 and the fan 80 supported by the supporting member 61 according to the present embodiment. Referring to FIGS. 6, 7, and 8, the supporting member 61 is arranged between the electric heater 70 and the fan 80. The electric heater 70 and the fan 80 are opposed to each other with a clearance.

The supporting member 61 includes a bottom plate 61B and side plates 61S arranged around the bottom plate 61B. The side plates 61S include a front side plate 61Sf arranged in a front portion thereof and a rear the side plates 61Sr arranged in a rear portion thereof. A flange 61F is arranged in an upper end of the side plates 61S.

The bottom plate 61B has a substantially rectangular outer shape. The fan casing 81 is coupled to a lower surface of the bottom plate 61B. An opening is formed in the center of the bottom plate 61B. The fan casing 81 is connected with a periphery of the lower surface of the bottom plate 61.

The side plates 61S are arranged so as to surround a space 61H existing between the fan 80 and the electric heater 70. The side plates 61S are formed in such a manner that the cross section of the space 61H gradually extends upward.

The opening at the upper end of the side plates 61S has a substantially rectangular shape. Two sides that regulate the opening provided at the upper end of the side plates 61S extend in the anteroposterior direction. Two sides that regulate the opening at the upper end of the side plates 61S extend in the vehicle width direction.

The electric heater 70 is supported by the flange 61F arranged at the upper end of the side plates 61S. The front end and the rear end of the electric heater 70 are connected with the flange 61F. The center of the electric heater 70 in the anteroposterior direction faces the space 61H. The side plates 61S support the plurality of electric heater 70 at the flange 61F.

Referring to FIG. 6, the electric heater 70 is arranged so that it is inclined in the anteroposterior direction. In the present embodiment, the electric heater 70 is arranged so that its rear end is arranged at a position lower than its front end.

Moreover, in the present embodiment, the electric heater 70 is arranged so that at least a part thereof including the rear end is arranged at a position lower than the upper surface of the floor plate 13. In the present embodiment, the electric heater 70 is arranged so that the part thereof including its rear end is arranged at a position lower than the upper surface of the floor plate 13. On the other hand, the electric heater 70 is arranged so that the part thereof including its front end is positioned at a position higher than the upper surface of the floor plate 13. Alternatively, the electric heater 70 may be arranged so that the entire electric heater 70 is arranged at a position lower than the upper surface of the floor plate 13.

Referring to FIG. 8, a discharge port 63 is arranged in a part of the supporting member 61. The inner space 61H of the supporting member 61 and the space external to the supporting member 61 are in conformity with each other via the discharge port 63. The bottom plate 61B is inclined downward toward the rear. The discharge port 63 is arranged in a boundary between a part of the rear end of the bottom plate 61B and the rear side plate 61Sr. As described above, the bottom plate 61B has a substantially rectangular outer shape. In the present embodiment, the discharge port 63 is arranged at a corner portion of the rear end of the bottom plate 61B. The discharge port 63 is arranged at each of two corners at the rear end of the bottom plate 61B.

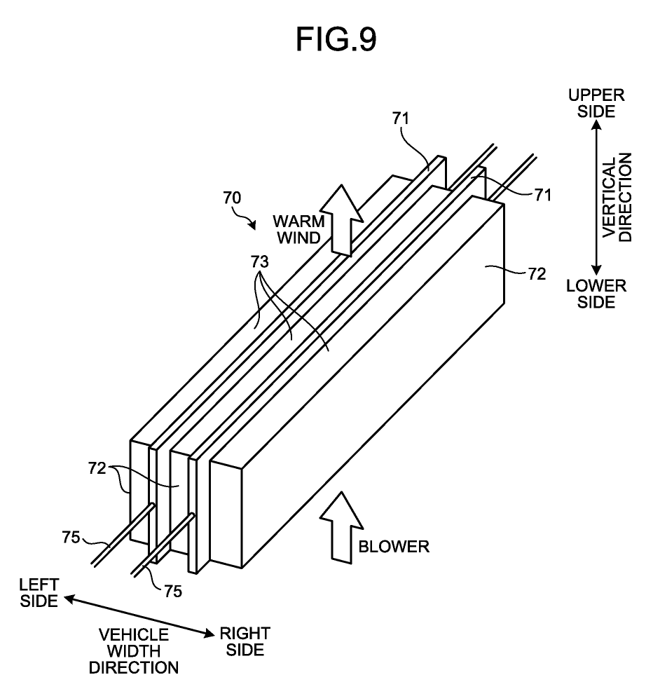

FIG. 9 is a perspective view which illustrates an example of the electric heater 70 according to the present embodiment. FIG. 7 illustrates one electric heater 70. Referring to FIG. 9, the electric heater 70 is connected with the battery via an electric cable 75 and includes two heating elements 71 which generates heat by a current supplied from the battery, a supporting member 72 which supports the heating elements 71, and a heat sink 73 arranged between the heating elements 71 and the supporting member 72.

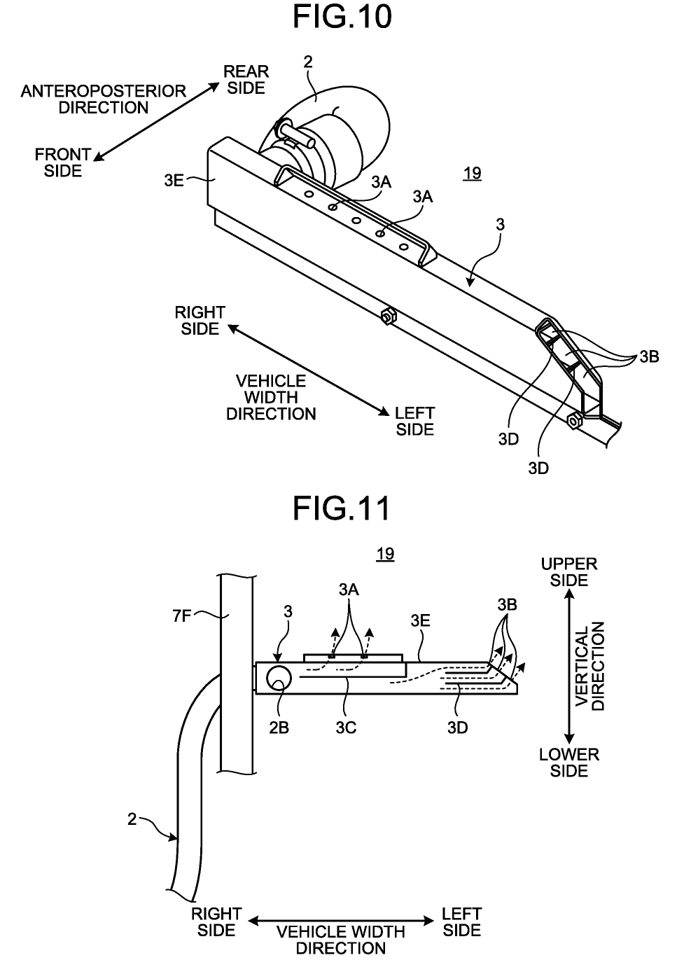

FIG. 10 is a perspective view which illustrates an example of the defroster 3 according to the present embodiment. FIG. 11 is a cross section of an example of the defroster 3 according to the present embodiment viewed from the front side.

The defroster 3 includes a casing 3E and guide members 3C and 3D arranged in the inner space of the casing 3E.

The guide member 3C guides air into an air intake 3A arranged on an upper surface of the casing 3E. The guide member 3D guides air into an air intake 3B arranged at a left end of the casing 3E.

Note that the above-described configuration of the defroster 3 according to the present embodiment is a mere example and the configuration of the defroster 3 is not limited thereby.

### Operation of the Heater Apparatus

Next, an example of an operation of the heater apparatus 1 according to the present embodiment will be described. If the driver intends to start the heater apparatus 1, the driver operates a heater start switch provided in the dashboard 15, and thereby the heater apparatus 1 is started. When the heater start switch is operated, the current is supplied to the electric heater 70 and the fan 80 starts turning. In the present embodiment, the electric heater 70 and the fan 80 are operated by electric power supplied from the battery which is the power source. Alternatively, the electric heater 70 and the fan 80 may be operated by electric power supplied from a battery different from the power source.

When the fan 80 is turned, the air in the space external to the housing 51 flows into the inner space of the housing 51 via the air intake 52. An air intake 82 is arranged in a lower portion of the front board 512. In the vertical direction, the fan 80 is arranged at a position higher than the air intake 82. When the fan 80 is turned, the air in the space external to the housing 51 flows from an air intake 82 arranged in the lower portion of the front board 512 into the inner space of the housing 51.

In the vertical direction, the electric heater 70 is arranged at a position higher than the fan 80. When the fan 80 is turned, at least a part of the air in the inner space of the housing 51 is supplied from the fan 80 to the electric heater 70.

As described above, an opening is provided in the center of the bottom plate 61B of the supporting member 61. When the fan 80 is turned, air flows into the space 61H of the supporting member 61 via the opening formed in the center of the bottom plate 61B.

The side plates 61S are arranged so as to surround the space 61H between the fan 80 and the electric heater 70. The space 61H is formed so that the cross section thereof becomes greater from the opening in the center of the bottom plate 61B toward the opening at the upper end of the side plates 61S. Blast generated at the fan 80 is guided by the side plates 61S to be efficiently supplied to the electric heater 70 arranged at the opening provided at the upper end of the side plates 61S.

The electric heater 70 faces the space 61H. The air fed from the fan 80 into the space 61H is brought into contact with the electric heater 70. The air is brought into contact with a surface of the heating elements 71 of the electric heater 70, a surface of the heat sink 73 heated by the heat from the heating elements 71, and a surface of the supporting member 72 heated by the heat from the heating elements 71. Due to the contact between the air and the electric heater 70, the temperature of the air is increased and warm air is generated.

Referring to FIG. 9, an inflow port to a space 70H of the electric heater 70 is oriented downward. Blast from the fan 80 flows into the space 70H via the inflow port for the space 70H. The air flown into the space 70H can be circulated into a clearance between mutually adjacent flat portions of the heat sink 73. The air which flows in the space 70H is brought into contact with the surface of the heating elements 71 of the electric heater 70, the surface of the heat sink 73 heated by the heating elements 71, and the surface of the supporting member 72 heated by the heating elements 71. The temperature of the air in the space 70H is increased in the above-described manner. The air with the increased temperature flows out from an outlet port for the space 70H of the electric heater 70, which is oriented upward. In the above-described manner, warm air is fed from the electric heater 70.

A part of the warm air brought into contact with the electric heater 70 and generated thereby is supplied from the warm air blowoff port 53 into a space above the floor plate 13. Moreover, a part of the warm air brought into contact with the heating elements 71 and thus generated at the electric heater 70 is supplied to the defroster 3 via the supply port 54 and the tube member 2.

The warm air blowoff port 53 is arranged in the first inclined board 515. In the vertical direction, the electric heater 70 is arranged at a position lower than the warm air blowoff port 53. At least a part of the warm air brought into contact with the electric heater 70 flows upward and then is blown off from the warm air blowoff port 53.

A supply port 84 is arranged in the second inclined board 516. In the vertical direction, the electric heater 70 is arranged at a position lower than the supply port 84. At least a part of the warm air brought into contact with the electric heater 70 flows upward and then flows into the flow path for the tube member 2 via the supply port 84.

The warm air generated in the inner space of the housing 51 is supplied into the inner space of the casing 3E via the supply port 54 and the tube members 2. The guide member 3C guides the warm air to the air intake 3A arranged on the upper surface of the casing 3E. The guide member 3D guides the warm air to the air intake 3B arranged at the left end of the casing 3E. The warm air is distributed extensively onto the windshield 19 in the above-described manner.

### Operation and Effect

As described above, according to the present embodiment, the heater apparatus 1 includes the electric heater 70 which generates heat by an electric power supplied from the battery accommodated in the battery chamber of the accommodation member 12. Accordingly, the heater apparatus 1 is capable of generating warm air without an internal combustion engine. With this configuration, also in battery forklifts, discomfort felt by the driver due to cold is alleviated and frost formation, ice accretion, and dew condensation on the windshield 19 that may occur due to cold are suppressed.

Moreover, according to the present embodiment, the housing 51, the electric heater 70, and the main unit 50 including and the fan 80 of the heater apparatus 1 are arranged in the step 14 arranged on the right side of the floor plate 13 in the vehicle width direction. With this configuration, the driver is allowed to step into or out from the vehicle via the step 14 arranged to the left of the floor plate 13 in the vehicle width direction.

In addition, according to the present embodiment, the rear end of the electric heater 70 is arranged at a position lower than the front end of the electric heater 70. With the above-described configuration, the feet of the driver placed on the floor plate 13 can be prevented from being excessively warmed. The main unit 50 of the heater apparatus 1 including the electric heater 70 is arranged in the step 14 disposed on the right side of the floor plate 13. If the rear end of the electric heater 70 is arranged at a high position, it is likely that radiant heat from the electric heater 70 directly acts on the feet of the driver placed on the floor plate 13. In this case, the feet of the driver is excessively warmed, which may result in causing discomfort of the driver. With the configuration in which the rear end of the electric heater 70 is arranged at a position lower than the front end of the electric heater 70, direct action of the radiant heat from the electric heater 70 on the feet of the driver placed on the floor plate 13 can be prevented. The feet of the driver placed on the floor plate 13 are warmed by the warm air of approximate temperature blown off from the warm air blowoff port 53. With the above-described configuration, the driver is allowed to carry out a work in a comfortable environment.

Moreover, in the present embodiment, in the flow path between the air intake 52 and the warm air blowoff port 53 for the inner space of the housing 51, the fan 80 is arranged between the air intake 52 and the electric heater 70, and the electric heater 70 is arranged between the fan 80 and the warm air blowoff port 53. More specifically, the air intake 52, the fan 80, the electric heater 70, and the warm air blowoff port 53 are arranged in this order in the direction of air flow. With this configuration, the air flown from the air intake 52 into the inner space of the housing 51 smoothly pass through the fan 80 and the electric heaters 70 to be blown off from the warm air blowoff port 53. In addition, in the present embodiment, a part of the warm air brought into contact with the electric heater 70 is supplied from the warm air blowoff port 53 into the space above the floor plate 13, and the other part of the warm air brought into contact with the electric heater 70 is supplied to the defroster 3 via the supply port 54 and the tube members 2. With this configuration, the warm air can be supplied into the space above the floor plates 13 and to the defroster 3 by using one main unit 50.

Moreover, according to the present embodiment, at least a part of the electric heater 70 including the rear end is arranged at a position lower than the upper surface of the floor plate 13. With this configuration, direct action of the radiant heat from the electric heater 70 on the feet of the driver placed on the floor plate 13 can be prevented. Moreover, if the electric heater 70 is arranged at a position higher than an upper surface of the floor plate 13, the housing 51 arranged at a position higher than the upper surface of the floor plate 13 may be excessively heated. In this case, if the feet of the driver placed on the floor plate 13 contact the housing 51 existing above the upper surface of the floor plate 13, excessive discomfort may be caused to the driver. With the configuration in which at least a part of the electric heater 70 including the rear end arranged at a position lower than the upper surface of the floor plate 13, discomfort to the driver is prevented.

In addition, according to the present embodiment, the warm air blowoff port 53 is arranged at a position higher than the upper surface of the floor plate 13. With this configuration, the warm air of approximately temperature blown off from the warm air blowoff port 53 is smoothly supplied to the feet of the driver placed on the floor plate 13. Moreover, with the configuration in which the warm air blowoff port 53 is arranged at a position higher than the upper surface of the floor plate 13, the warm air blown off from the warm air blowoff port 53 is smoothly supplied not only onto the lower portion of the body of the driver but also onto the upper portion of the driver.

In addition, according to the present embodiment, the housing 51 is arranged so that its upper end is arranged at a position lower than the connector 16 for connection with a charging equipment for charging the battery. In the configuration in which both the housing 51 and the connector 16 are arranged in the right portion of the vehicle body 10, because the upper end of the housing 51 is thus arranged at a position lower than the connector 16, a work for connecting the charging equipment and the connector 16 can be smoothly performed.

Moreover, according to the present embodiment, the supporting member 61 is arranged between the electric heater 70 and the fan 80. With this configuration, the space 61H is formed between the electric heater 70 and the fan 80. Because the electric heater 70 and the fan 80 are separated from each other, the blast from the fan 80 is distributed to the entire electric heater 70.

In addition, according to the present embodiment, the supporting member 61 includes the bottom plate 61B which supports the fan 80 via the fan casing 81 and the side plates 61S that are arranged around the bottom plate 61B and support the electric heater 70. With the above-described configuration, the blast from the fan 80 is guided by the side plates 61S to be efficiently supplied to the electric heater 70 supported by the side plates 61S at the flange 60F thereof formed at their upper end.

Moreover, according to the present embodiment, the discharge port 63 is arranged in a part of the supporting member 61. It is likely that rainwater enters the space 61H of the supporting member 61. Moreover, if the forklift 100 is used in cold districts, it is likely that snow enters the space 61H. Further, in cold districts, it is likely that the driver enters the vehicle with snow attached onto the footwear, and the snow may fall from the shoes onto the floor plate 13 and the melted snow water may likely to enter the space 61H. If the state in which foreign matters having entered the space 61H is not immediately resolved, the heater apparatus 1 may be degraded or fail. With the configuration in which the discharge port 63 is arranged in a part of the supporting member 61, even any foreign matter has entered the space 61H, the foreign matters can be discharged from the discharge port 63. With this configuration, degradation or failure of the heater apparatus 1 is prevented.

Moreover, according to the present embodiment, the bottom plate 61B is inclined in relation to the horizontal plane and the discharge port 63 is arranged at the boundary between the lower end of the bottom plate 61B and the side plates 61S. With this configuration, the foreign matter is smoothly discharged from the space 61H through the discharge port 63 due to the action of gravity.

In addition, according to the present embodiment, the housing 51 includes the main body member 51A, which is supported by the step 14 and has the opening on the outer side in the vehicle width direction, and the cover member 51B, which is detachbly attached to the main body member 51A to cover the opening of the main body member 51A. With this configuration, in performing a maintenance work for the main unit 50 or a work for exchanging parts of the main unit 50, the driver or the worker is allowed to perform the work on the devices or members arranged in the inner space of the housing 51 via the opening of the main body member 51A arranged on the right side in the vehicle width direction by disengaging the cover member 51B. Moreover, with the configuration in which the opening of the main body member 51A is covered by the cover member 51B, the devices and the members arranged in the inner space of the housing 51 are sufficiently protected.

In addition, according to the present embodiment, the defroster 3 is provided, which is connected with the housing 51 via the tube member 2 and supplies the warm air from the housing 51 onto the windshield 19 of the forklift 1. The housing 51 includes the first inclined plane of the first inclined board 51, which is inclined upward toward the outside in the vehicle width direction, and the second inclined plane of the second inclined board 516, which is arranged at the outside of the first inclined plane in the vehicle width direction and inclined downward toward the outside in the vehicle width direction. The warm air blowoff port 53 is arranged in the first inclined plane, and the supply port 54 of the housing 51 connected with the tube member 2 is arranged in the second inclined plane. With this configuration, the warm air brought into contact with the electric heater 70 is guided by each of the first inclined board 515 and the second inclined board 516 to be smoothly branched toward the warm air blowoff port 53 and the supply port 54, respectively.

Note that in the embodiment described above, the work vehicle 100 is the forklift 100. The components described in the above embodiment can be applied to a work vehicle which uses a battery as a drive source. For example, the forklift 100 may be a wheel loader, a hydraulic excavator, or a dump truck which uses a battery as a drive source.

### REFERENCE SIGNS LIST

1 Heater apparatus, 2 Tube member, 2A First tube member, 2B Second tube member, 3 Defroster, 3A Air intake, 3B Air intake, 3C Guide member, 3D Guide member, 3E Casing, 10 Vehicle body, 11 Frame, 12 Accommodation member, 13 Floor plate, 14 Step, 15 Dashboard, 16 Connector, 17 Pillar, 17F Front pillar, 17R Rear pillar, Head guard, 19 Windshield, 20 Traveling device, 21 Front wheel, 21T Tire, 22 Rear wheel, 22T Tire, 30 Cargo handling device, 31 Seat tube, 32 Fork, 33 Tilt cylinder, 34 Lift cylinder, 40 Driving seat, 41 Steering wheel, 42 Accelerator pedal, 43 Brake pedal, 44 Operation lever, 50 Main unit, 51 Housing, 51A Main body member, 51B Cover member, 52 Air intake, 53 warm air blowoff port, 54 Supply port, 60 Louver, 61 Supporting member, 61B Bottom plate, 61F Flange, 61H Space, 61S Side plate, 61Sf Side plate, 61Sr Rear side plate, 62 Coupling member, 63 Discharge port, 65 Electronic circuit, 66 Control device, 70 Electric heater, 70H Space, 71 Heating element, 72 Supporting member, 73 Heat sink 75 Electric cable, 80 Fan, 81 Fan casing, 100 Forklift (work vehicle), 511 Front board, 512 Rear board, 513 Upper board, 514 Inner board, 515 First inclined board, 516 second inclined board.

1. A heater apparatus comprising:
a housing which is arranged in a step positioned at an outer side of a floor plate of a vehicle body of a work vehicle in a vehicle width direction and has an air intake and a warm air blowoff port;
an electric heater arranged in an inner space of the housing;
a fan which supplies air to the electric heater; and
a supporting member which supports the electric heater and the fan,
wherein the electric heater is arranged so that a rear end of the electric heater is arranged at a position lower than a front end of the electric heater.

2. The heater apparatus according to claim 1,
wherein the air intake, the fan, the electric heater, and the warm air blowoff port are arranged in this order, and
wherein warm air from the electric heater is supplied to a space above the floor plate via the warm air blowoff port.

3. The heater apparatus according to claim 1, wherein at least a part of the electric heater including the rear end is arranged at a position lower than an upper surface of the floor plate.

4. The heater apparatus according to claim 1, wherein the warm air blowoff port is arranged at a position higher than an upper surface of the floor plate.

5. The heater apparatus according to claim 1, wherein the housing is arranged so that an upper end of the housing is arranged at a position lower than a connector of the vehicle body, the connector being connected with a charging equipment which charges a battery which is a power source of the work vehicle.

6. The heater apparatus according to claim 1, wherein a discharge port is provided in a part of the supporting member.

7. The heater apparatus according to claim 1, wherein the housing comprises:
a main body member which is supported by the step and has an opening on an outer side in the vehicle width direction; and
a cover member which is detachably attached to the main body member and covers the opening.

8. The heater apparatus according to claim 1, comprising a defroster which is connected with the housing via a tube member and supplies warm air from the housing onto a windshield of the work vehicle.

9. The heater apparatus according to claim 8, wherein the housing comprises:
a first inclined plane which is inclined upward toward an outside in the vehicle width direction; and
a second inclined plane which is arranged at an outer side of the first inclined plane in the vehicle width direction and inclined downward toward the outside in the vehicle width direction,
wherein the warm air blowoff port is provided in the first inclined plane, and
wherein a supply port of the housing connected with the tube member is provided in the second inclined plane.

10. A work vehicle comprising the heater apparatus according to claim 1.
